(19) United States
(12) Patent Application Publication
(10) Pub. No.: US 2023/0324782 A1
(43) Pub. Date: Oct. 12, 2023

(54) PROJECTION LIGHT PATH WITH OFFSET ANGLE AND PROJECTOR

(71) Applicant: Shenzhen Jingyi Mould Co., Ltd., Shenzhen (CN)

(72) Inventors: Xunzhong Zhao, Shenzhen (CN); Disheng Chen, Shenzhen (CN)

(21) Appl. No.: 18/334,400

(22) Filed: Jun. 14, 2023

(30) Foreign Application Priority Data
Mar. 20, 2023 (CN) 202310266978.1

(51) Int. Cl. G03B 21/20; G03B 21/00; G03B 17/54; G03B 21/28

(52) U.S. Cl. CPC G03B 21/208; G03B 21/006; G03B 21/2073; G03B 21/2033; G03B 17/54; G03B 21/28

(57) ABSTRACT

The present disclosure discloses a projection light path with an offset angle, including a light source, a light cone, a first Fresnel lens, a polaroid, a screen, and a second Fresnel lens. Dimensional centers of the six components are on the same axial line, and the dimensional center of the second Fresnel lens does not overlap an optical thread center. The present disclosure further discloses a projector. According to the present disclosure, due to the adoption of the eccentric Fresnel lenses, optical centers of the Fresnel lenses and a dimensional center of an imaging camera lens are on the same axial line are on the same axial line, which displays a complete projected picture on an upper half of a projection region, and effectively solves the problem that a lower half of a projected picture of a projector is easily covered by a desktop in the prior art.

### TECHNICAL FIELD

The present disclosure relates to the technical field of protection equipment, and in particular, to a projection light path with an offset angle and a projector.

### BACKGROUND

At present, single-liquid crystal display (LCD) projectors sold on the market basically adopt a 0% offset mode, that is, a display center of an LCD screen, a center of a Fresnel lens, and a center of a projection lens are on the same axis, and a projected image is centrosymmetric with respect to the screen. A lens of the single-LCD projector with the 0 offset is relatively simply designed. However, in an actual projection process, a lower half of a projected picture is easily covered by a desktop, which seriously affects the experience of a customer. In order to eliminate the problem that the lower half of the projected picture is covered by the desktop, many manufacturers adopt methods for increasing a height of a projector, including adding a supporting frame below the projector or making projector upright. The two methods can only solve some of the problems. Therefore, a projection light path with an offset angle and a projector are provided to solve the problem that the lower half of the projected picture of the projector is easily covered by the desktop in the prior art.

### SUMMARY

A first objective of the present disclosure is to provide a projection light path with an offset angle and a projector, so as to solve the problem that a lower half of a projected picture of a projector is easily covered by the desktop in the prior art.

The projection light path with an offset angle and the projector of the present disclosure can be achieved by the following technical solutions:

The present disclosure discloses a projection light path with an offset angle, including a light source, a light cone, a first Fresnel lens, a polaroid, a screen, and a second Fresnel lens. Dimensional centers of the six components are on the same axial line, and the dimensional center and optical thread center of the second Fresnel lens do not overlap.

In one implementation, the projection light path with the offset angle of the present disclosure further includes an imaging camera lens; the imaging camera lens is arranged on a side edge of the second Fresnel lens; and the dimensional center of the imaging camera lens and the optical thread center of the second Fresnel lens are on the same axial line.

In one implementation, the light source adopts a light-emitting diode (LED) light source.

In one implementation, the first Fresnel lens is rectangular, and the dimensional center of the first Fresnel lens overlaps the optical thread center.

In one implementation, the screen adopts a liquid crystal display (LCD) screen.

In one implementation, the second Fresnel lens is rectangular, and the dimensional center of the second Fresnel lens does not overlap the optical thread center.

In one implementation, the projection light path with the offset angle of the present disclosure further includes an imaging camera lens and a reflector mirror; the imaging camera lens is arranged on a side edge of the second Fresnel lens and forms an angle of 90 degrees from the second Fresnel lens; the reflector mirror is arranged between the second Fresnel lens and the imaging camera lens and forms an angle of 45 degrees from the second Fresnel lens; and dimensional centers of the imaging camera lens and the reflector mirror are on the same axial line.

A projector is provided, including any of the above projection light paths.

Compared with the prior art, the projection light path with the offset angle of the present disclosure has the beneficial effects:

According to the projection light path with the offset angle and the projector of the present disclosure, the light source, the light cone, the first Fresnel lens, the polaroid, the screen, and the second Fresnel lens are arranged in sequence and have the dimensional centers on the same axial line. The second Fresnel lens adopts an eccentric design, and the optical center of the second Fresnel lens and the dimensional center of the imaging camera lens are on the same axial line, so that a whole projected picture is displayed on an upper half of a projection region. Meanwhile, it is not necessary to add a support to the projector or increase the height of the camera lens, so that a function of preventing the projected picture from being covered by the desktop can be achieved.

According to the projection light path with the offset angle and the projector of the present disclosure, the reflector mirror is arranged between the second Fresnel lens and the imaging camera lens, so that a size of the projector can be reduced to a certain extent, which is convenient for transportation and storage of the projector.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a schematic structural diagram of a first embodiment of a projection light path with an offset angle according to the present disclosure, including a second Fresnel lens;

FIG. 2 is a schematic diagram of a sectional structure of the first embodiment of the projection light path with an offset angle according to the present disclosure shown in FIG. 1;

FIG. 3 is a schematic structural diagram of the second Fresnel lens shown in FIG. 1;

FIG. 4 is a schematic diagram of a side sectional structure of a second embodiment of a projection light path with an offset angle according to the present disclosure; and

FIG. 5 is a schematic diagram of a sectional structure of another view of the second embodiment of the projection light path with an offset angle according to the present disclosure shown in FIG. 4.

Numerals in the drawings: 11: light source; 12: light cone; 13: first Fresnel lens; 14: polaroid; 15: screen; 16: second Fresnel lens; 161: optical thread center; 17: imaging camera lens; 18: reflector mirror; and 20: projection region.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. The components of the embodiments of the present disclosure generally described and shown in the drawings here can be arranged and designed in a variety of different configurations.

Therefore, the following detailed description for the embodiments of the present disclosure provided in the accompanying drawings is not intended to limit the scope of the claimed present disclosure, but merely represents selected embodiments of the present disclosure. All other embodiments obtained by those of ordinary skill in the art based on the embodiments in the present disclosure without creative work shall fall within the protection scope of the present disclosure.

### First Embodiment

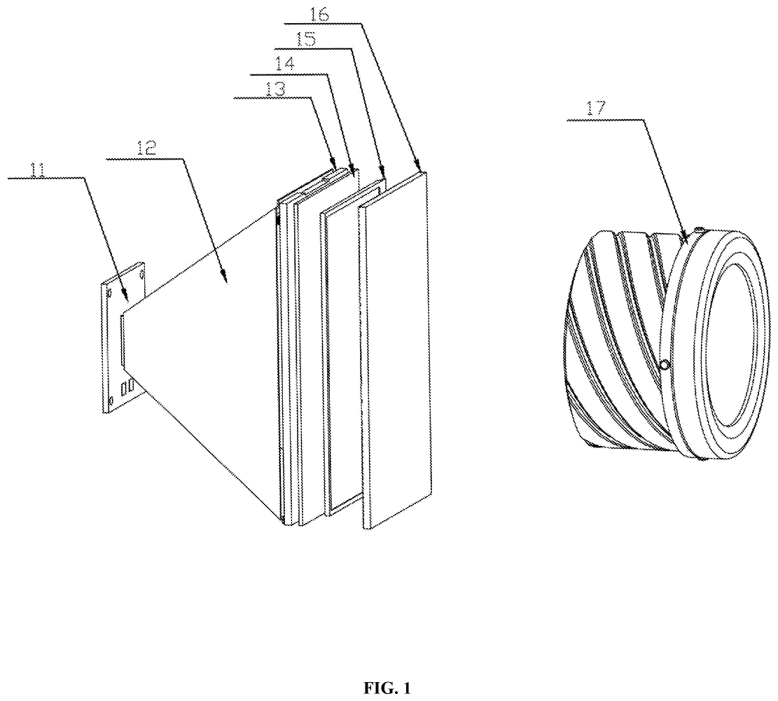

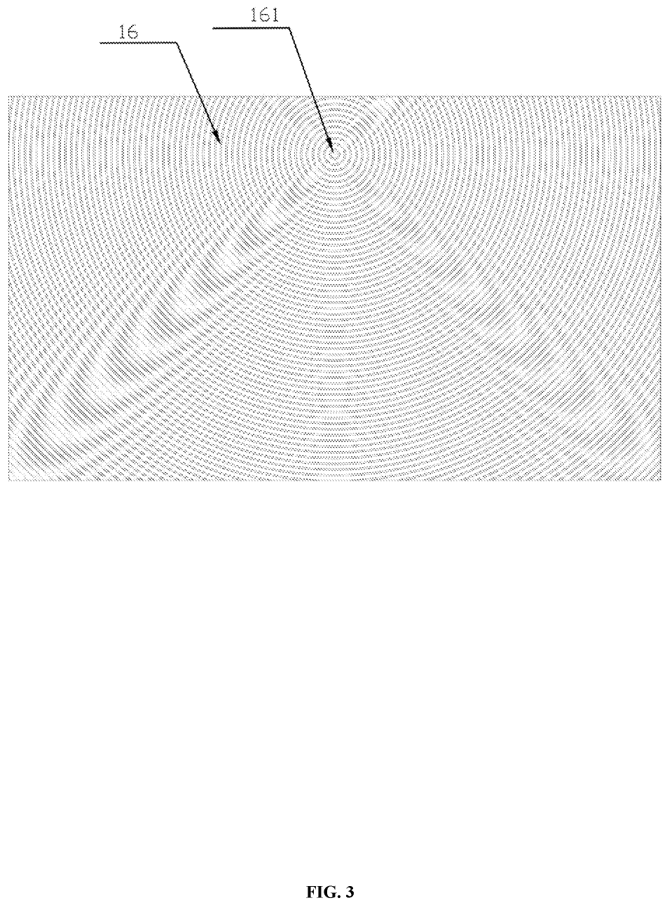

Referring to FIG. 1 to FIG. 3, in this embodiment, a projection light path with an offset angle of the present disclosure can include a light source 11, a light cone 12, a first Fresnel lens 13, a polaroid 14, a screen 15, a second Fresnel lens 16, and an imaging camera lens 17. The light source 11, the light cone 12, the first Fresnel lens 13, the polaroid 14, the screen 15, and the second Fresnel lens 16 are arranged in sequence, dimensional centers of which are on the same axial line. An optical thread center 161 of the second Fresnel lens 16 is deviated from the dimensional center of the screen 15. The light source 11 is a light-emitting main body of a projector. The light cone 12 is arranged between the light source 11 and the first Fresnel lens 13. An effect of the light cone 12 is to collect and gather light emitted by the light source 11. The first Fresnel lens 13 corrects the light passing through the light cone 12 from scattered light into parallel light. The polaroid 14 is arranged between the first Fresnel lens 13 and the screen 15. An effect of the polaroid 14 is to filter out P light and transmit effective S light. The screen 15 is a source of images and colors of the projector. The second Fresnel lens 16 is arranged on a side edge of the screen 15, and the dimensional size of the second Fresnel lens does not overlap the optical thread center 161. The second Fresnel lens 16 converges the light transmitted through the screen 15 onto the imaging camera lens 17. The imaging camera lens 17 is arranged on a side edge of the second Fresnel lens 16, and a dimensional size of the imaging camera lens and the optical thread center 161 of the second Fresnel lens 16 are on the same axial line. By using an optical method, an image projected by the imaging camera lens 17 is located at an upper half of a projection region 20.

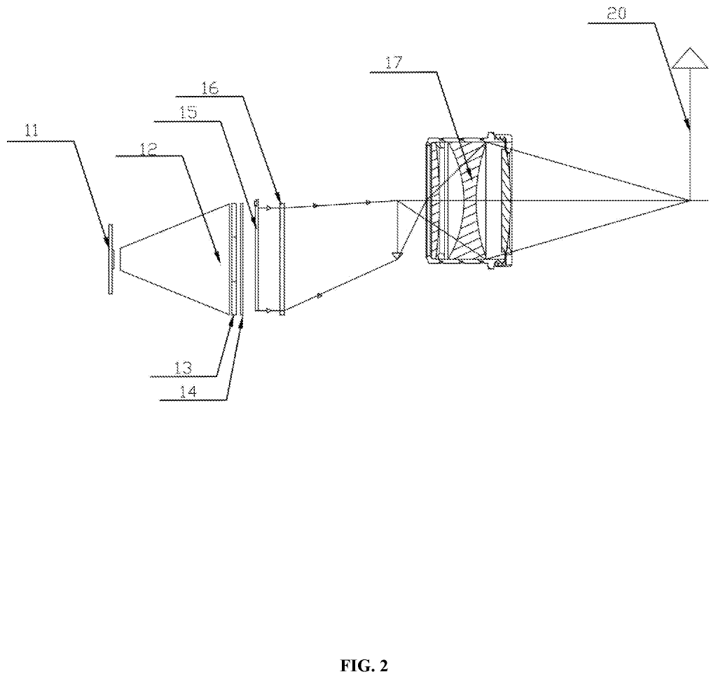

Referring to FIG. 1 and FIG. 2, in this embodiment, the light source 11 adopts an LED light source. The first Fresnel lens 13 is rectangular, and a dimensional center of the first Fresnel lens overlaps the optical thread center. The screen 15 adopts an LCD screen. The second Fresnel lens 16 is rectangular, and the dimensional center and optical thread center 161 of the second Fresnel lens do not overlap.

### Second Embodiment

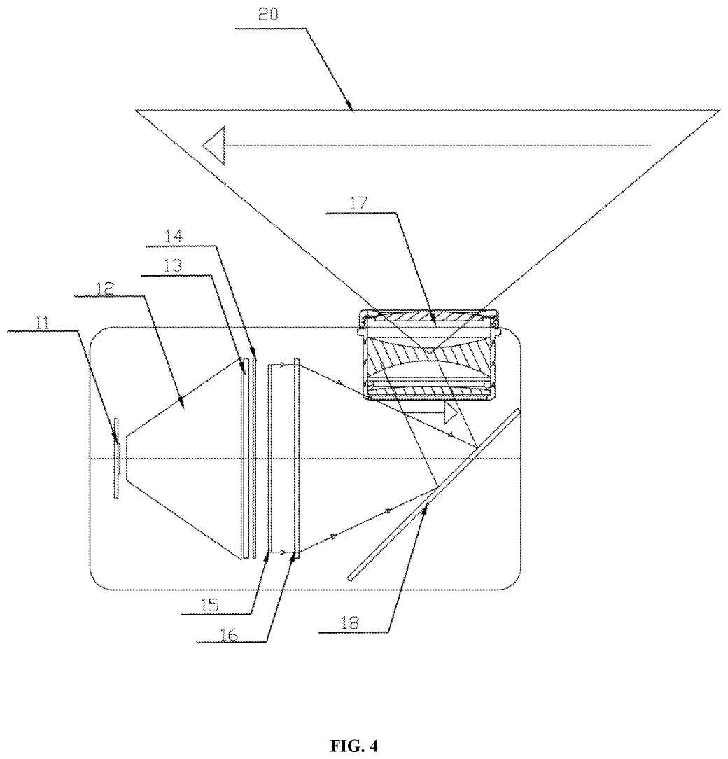

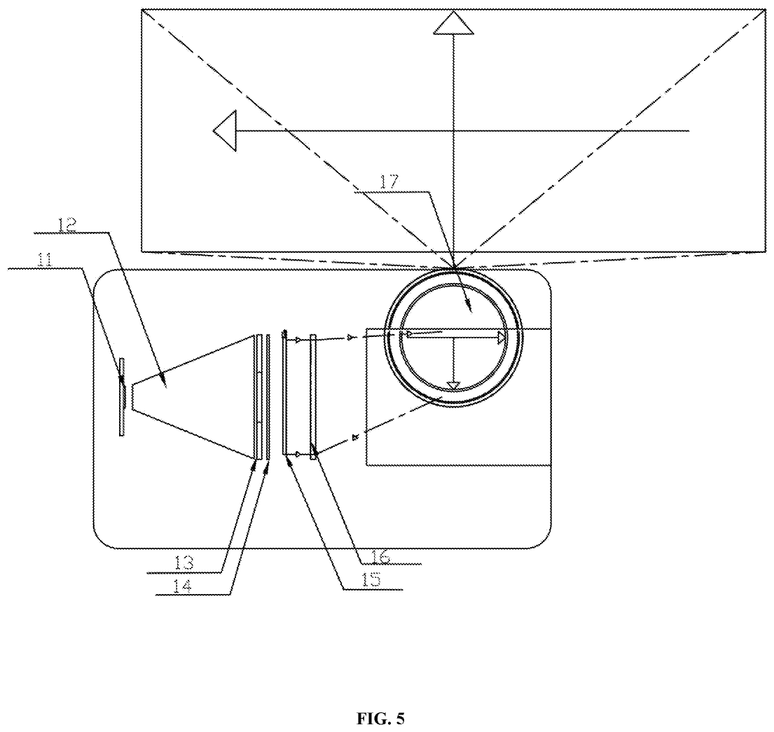

Referring to FIG. 4 and FIG. 5, in this embodiment, a projection light path with an offset angle of the present disclosure can include a light source 11, a light cone 12, a first Fresnel lens 13, a polaroid 14, a screen 15, a second Fresnel lens 16, an imaging camera lens 17, and a reflector mirror 18. The light source 11, the light cone 12, the first Fresnel lens 13, the polaroid 14, the screen 15, and the second Fresnel lens 16 are arranged in sequence, dimensional centers of which are on the same axial line. The light source 11 is a light-emitting main body of a projector. The light cone 12 is arranged between the light source 11 and the first Fresnel lens 13. An effect of the light cone 12 is to collect and gather light emitted by the light source 11. The first Fresnel lens 13 corrects the light passing through the light cone 12 from scattered light into parallel light. The polaroid 14 is arranged between the first Fresnel lens 13 and the screen 15. An effect of the polaroid 14 is to filter out P light and transmit effective S light. The screen 15 is a source of images and colors of the projector. The second Fresnel lens 16 is arranged on a side edge of the screen 15, and the dimensional size of the second Fresnel lens does not overlap the optical thread center 161. The second Fresnel lens 16 converges the light transmitted through the screen 15 onto the reflector mirror 18. The imaging camera lens 17 is arranged on a side edge of the second Fresnel lens 16 and forms an angle of 90 degrees from the second Fresnel lens 16. In such a design, it is convenient to reduce a size of the whole projection light source. The reflector mirror 18 is arranged between the second Fresnel lens 16 and the imaging camera lens 17 and forms an angle of 45 degrees from the second Fresnel lens 16. Dimensional centers of the imaging camera lens 17 and the reflector mirror 18 are on the same axial line. By using an optical method, an image projected by the imaging camera lens 17 is located at an upper half of a projection region 20.

A projector of the present disclosure includes any of the above projection light paths.

It should be noted that according to the projection light path with an offset angle of the present disclosure, since the eccentric second Fresnel lens 16 is used, and the optical center of the second Fresnel lens 16 and the dimensional size of the imaging camera lens 17 are on the same axial line. The axial line is deviated from the dimensional center of the screen 15 (that is, offset projection). By using the optical method, the whole projected picture is displayed above a desktop, thereby avoiding the problem that the desktop covers a lower half of the projected picture.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. A projection light path with an offset angle, comprising a light source, a light cone, a first Fresnel lens, a polaroid, a screen, and a second Fresnel lens, wherein dimensional centers of the six components are on the same axial line, and the dimensional center and optical thread center of the second Fresnel lens do not overlap.

2. The projection light path with the offset angle according to claim 1, further comprising an imaging camera lens, wherein the imaging camera lens is arranged on a side edge of the second Fresnel lens; and a dimensional center of the imaging camera lens and the optical thread center of the second Fresnel lens are on the same axial line.

3. The projection light path with the offset angle according to claim 2, wherein the light source adopts a light-emitting diode (LED) light source.

4. The projection light path with the offset angle according to claim 2, wherein the first Fresnel lens is rectangular, and the dimensional center of the first Fresnel lens overlaps the optical thread center.

5. The projection light path with the offset angle according to claim 2, wherein the screen adopts a liquid crystal display (LCD) screen.

6. The projection light path with the offset angle according to claim 2, wherein the second Fresnel lens is rectangular, and the dimensional center of the second Fresnel lens does not overlap the optical thread center.

7. The projection light path with the offset angle according to claim 1, further comprising an imaging camera lens and a reflector mirror, wherein the imaging camera lens is arranged on a side edge of the second Fresnel lens and forms an angle of 90 degrees from the second Fresnel lens; the reflector mirror is arranged between the second Fresnel lens and the imaging camera lens and forms an angle of 45 degrees from the second Fresnel lens; and dimensional centers of the imaging camera lens and the reflector mirror are on the same axial line.

8. A projector, comprising the projection light path according to any one of claims 1 to 7.
